(19) United States
(12) Patent Application Publication
(10) Pub. No.: US 2003/0146998 A1
(43) Pub. Date: Aug. 7, 2003

(54) Small-size imaging apparatus, in particular photographic appliance or camera

(76) Inventors: Elko Doering, (US); Joachim Grupp, Enges (CH); Beat Pfefferli, Thielle-Wavre (CH)

Correspondence Address: SUGHRUE MION, PLLC, 2100 PENNSYLVANIA AVENUE, N.W., WASHINGTON, DC, 20037, US

(21) Appl. No.: 10/343,223

(22) PCT Filed: Jul. 23, 2001
(86) PCT No.: PCT/EP01/08533

(30) Foreign Application Priority Data
Aug. 11, 2000 (EP) 00202834.8

(51) Int. Cl. H04N 5/225

(52) U.S. Cl. 348/340; 348/374

(57) ABSTRACT

The image recording apparatus (3) of small dimensions includes a sensor (4) and a lens assembly with focussing lenses (8, 9, 10) arranged in a frame (12). The sensor is arranged on a first face (16) of the substrate (18), which has an aperture (20) facing which the photosensitive surface (6) of said sensor is arranged. Means for positioning the lens assembly during assembly thereof are provided, formed particularly by an optical element (11).

The present invention concerns an image recording apparatus of small dimensions, particularly a camera or video camera, wherein there is provided a sensor formed of a plurality of pixels used for detecting images. This apparatus includes at least one focussing lens whose optical axis substantially intersects the geometric centre of the photosensitive surface of the sensor.

In particular, the image recording apparatus according to the invention is intended to be incorporated in a multi-functional portable device, particularly a mobile telephone, a watch or a portable microcomputer.

There is known from U.S. Pat. No. 5,130,804 an image recording apparatus including a sensor, a lens arranged in a frame, and a support with an aperture opposite which, on either side of said support, the lens and a photosensitive surface of said sensor are arranged. The sensor itself is formed of a substrate defining the photosensitive surface, this substrate being arranged at the bottom of a case to which it is electrically connected in a conventional manner. This case includes electric connections connecting the substrate to external contact pads of the case to allow electrical connection to said support on which electronic units are mounted. This apparatus has a drawback since it is not easy, during assembly thereof, to align the optical axis of the lens assembly and the centre of the aperture precisely. Likewise, the positioning of the sensor relative to said aperture is not ensured. Moreover, it is not easy to mount the sensor on the support while ensuring that the corresponding contact pads are properly opposite each other.

The object of the present invention is to overcome the aforementioned drawbacks

Another object of the invention is to provide an image recording apparatus of small dimensions wherein the electrical connections between the sensor pixels and the electronic units for processing and/or exploiting the electronic signals provided by said pixels are easily established during manufacture of said apparatus.

Thus, the invention concerns an image recording apparatus as defined in claim 1 annexed hereto.

The present invention will be described in detail hereinafter using the following description, made with reference to the annexed drawings, given by way of non-limiting example and in which:

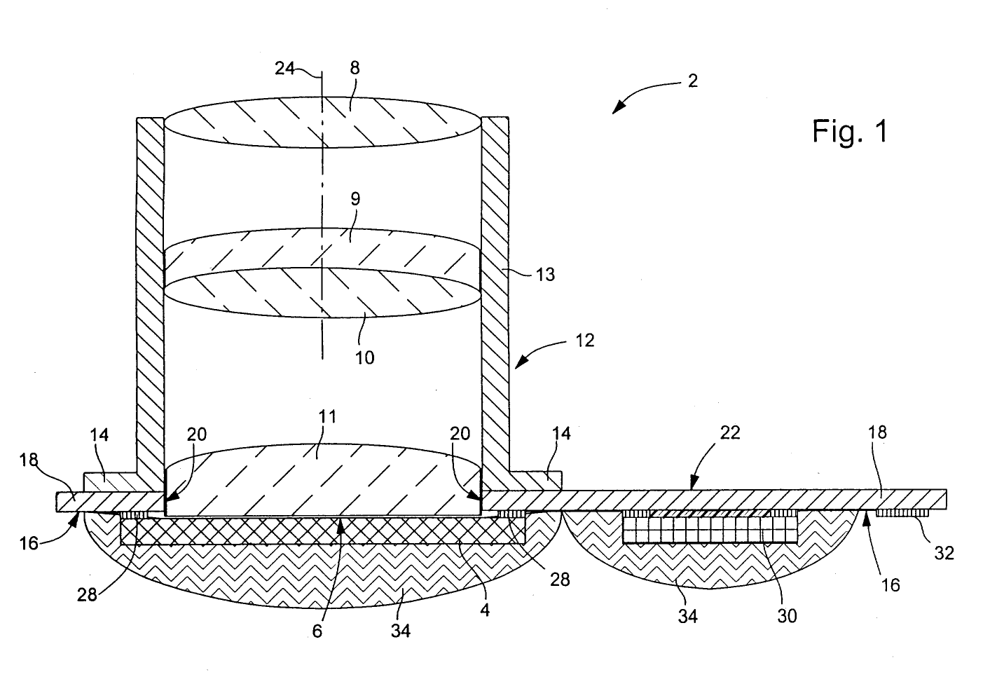

FIG. 1 shows schematically an embodiment of the image recording apparatus according to the invention;

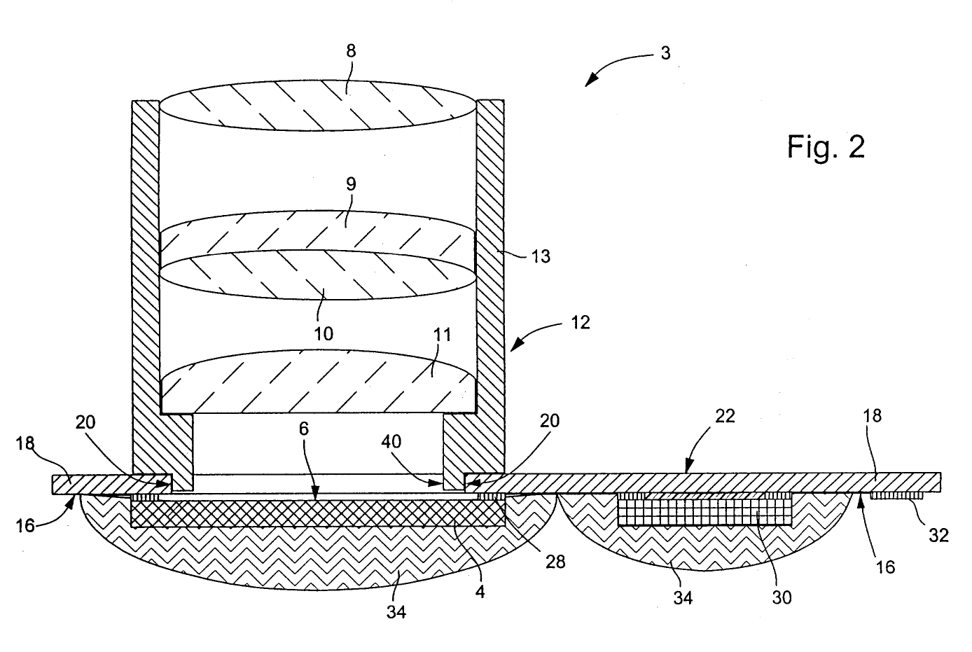

FIG. 2 shows a second embodiment of the apparatus of FIG. 1.

FIG. 1 schematically shows an image recording apparatus 2 forming a compact and autonomous module. However, it is intended to be integrated in a portable device, particularly a telephone or object worn on the wrist like a watch. This apparatus is formed of an image sensor 4, having a photosensitive surface 6 and a lens assembly including focussing lenses 8, 9, 10 and 11 at least partially mounted in a frame. 12, which defines a tube 13 having a through aperture and an end shield 14 located at the inner end of the tube, i.e. on the sensor side. The outer end of the tube is closed by lens 8. Sensor 4 is mounted on the lower face 16 of a support 18 that has an aperture 20 of substantially equal or larger dimensions to those of photosensitive surface 6 which is located facing this aperture and substantially centred thereon.

It will be noted that certain lenses can also have an infrared or ultraviolet filter function, particularly lens 11. In an alternative embodiment, optical element 11 is formed only by a filter having two flat parallel faces. Optical element 11 can be fixed either to frame 12 of the lens assembly, or to substrate 18 by being for example simply driven into aperture 20, or it may be fixed directly to sensor 4. These various possibilities allow alternative embodiments for those skilled in the art.

According to the invention, means for positioning the lens assembly, during its assembly, relative to aperture 20 and/or sensor 4, are provided. In a preferred embodiment, these positioning means are also used for positioning the sensor relative to said aperture, such that optical axis 24 of the lens assembly and the centre of the photosensitive surface of the sensor are substantially aligned.

In a first preferred embodiment, said positioning means are formed by optical element 11 which is fixedly arranged in aperture 20 with its lateral wall rising above upper face 22 of support 18. The dimensions of aperture 20 are determined such that the optical element is positioned in this aperture via the wall thereof.

In a variant wherein optical element 11 is fixed to sensor 4 prior to assembly, this element enables the sensor to be positioned when it is assembled on substrate 18. Moreover, in this case, element 11 is used for positioning frame 12 and thus the lens assembly relative to sensor 4. For example, element 11 is bonded to photosensitive surface 6. This variant does not prevent aperture 20 having larger dimensions than those of optical element 11.

It will also be noted that frame 12 is shown schematically here and that it can take various forms and in particular, have a non-rectilinear internal or external profile. Frame 12 can be fixed to substrate 18 in various ways available to those skilled in the art, particularly by bonding.

Sensor 4 is formed of a semiconductor substrate, at the surface of which are arranged pixels defining photosensitive surface 6. These pixels are connected by electric paths to electric contact bump 28 with corresponding paths arranged on lower face 16 of the support. Various conductive paths connecting the contact pads to sensor 4 are arranged on this face 16, with at least one electronic unit 30. Peripheral contact pads 32 can also be provided for providing the processed or partially processed images to exploitation means, particularly display means for the images recorded by apparatus 2.

Sensor 4 and electronic unit 30 are protected by means of a resin 34. This resin 34 also rigidities the back part of substrate 18 and holds the electric connections between the contact pads arranged on substrate 18 and the connection pads or bumps 28 of the sensor. It will be noted that sensor 4 may have only contact pads formed of a fine surface metallisation, the electric connection being achieved by means of an anisotropic adhesive or any other intermediate means known to those skilled in the art.

FIG. 2 shows a second embodiment of the invention. The references already described in detail hereinbefore will not be described again here.

Image recording apparatus 3 is differs from that of FIG. 1 in that the lens assembly carries all the transparent optical elements inside tube 13, and inner optical element 11 does not penetrate aperture 20 of substrate 18. Here, the positioning of the lens assembly, during assembly thereof, relative to aperture 20, is achieved by a lower part 40 of frame 12 which penetrates the aperture and is fitted therein.

Other means for positioning the lens assembly, during assembly thereof, relative to aperture 20 can be provided. The same is true for sensor 4.

It will be noted finally that support 18 can advantageously have a flexible portion able to bend between a first part supporting the sensor and the lens assembly and a second part carrying other units, particularly electronic unit 30. This enables the second part to be folded down under the first part to obtain a very compact apparatus where unit 30 is located facing sensor 4, in the extension of the lens assembly.

1. Image recording apparatus of small dimensions formed of a sensor (4) and a lens assembly (8, 9, 10, 12), arranged respectively on either side of a support (18) having an aperture (20) for the passage of light focussed by said lens assembly, said sensor having a photosensitive surface (6) locate facing said aperture, characterised in that said apparatus includes means for positioning (11; 40) said lens assembly, during assembly thereof, relative to said aperture and/or said sensor.

2. Apparatus according to claim 1, characterised in that said positioning means (11) are also used for positioning said sensor, during assembly thereof, relative to said aperture, such that the optical axis (24) of said lens assembly and the centre of said photosensitive surface are substantially aligned.

3. Apparatus according to claim 1 or 2, characterised in that said lens assembly is formed of a frame (12) in which at least a first optical lens is arranged (8, 9, 10), said frame having a through aperture with an external end closed by said first lens and an inner end located facing said aperture.

4. Apparatus according to claim 3, characterised in that it includes a transparent optical element (11) fixedly arranged in said aperture of said support, said positioning means being formed by said optical element.

5. Apparatus according to claim 4, characterised in that said optical element is bonded onto said photosensitive surface before said sensor is mounted on said support.

6. Apparatus according to claim 4 or 5, characterised in that the dimensions of said aperture are determined such that said optical element is positioned in said aperture by their respective lateral walls.
